(19) United States
(12) Patent Application Publication
(10) Pub. No.: US 2004/0114055 A1
(43) Pub. Date: Jun. 17, 2004

(54) Apparatus, method, and medium including computer readable code for measuring noise of an image signal

(75) Inventor: Pil-Ho Yu, Suwon-city (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-city (KR)

(21) Appl. No.: 10/725,586

(22) Filed: Dec. 3, 2003

(30) Foreign Application Priority Data
Dec. 12, 2002 (KR) 2002-79292

(51) Int. Cl. H04N 9/64

(52) U.S. Cl. 348/700; 348/180

(57) ABSTRACT

An apparatus, method, and medium including computer readable code for measuring noise of an image signal, to precisely measure the noise regardless of a spatial frequency component of the input image signal. The apparatus includes a block average calculator for dividing a picture of the input image signal into a desired number of blocks and then calculating an average luminance value for each divided block, a delay for delaying the picture of the input image signal by one period, an SAD calculator for calculating an absolute difference between the average luminance value of the present picture and the average luminance value of the picture of the a delayed image signal, in on a per block basis, and a picture noise selector for selecting a desired number-th absolute difference as a picture noise when the absolute differences calculated by the SAD calculator are arranged, in turn, from a smallest value toward a largest value. Therefore, the apparatus, method, and medium including computer readable code reduce a variability of a measured noise value between a present region and a previous region, thereby being capable of stably measuring noise in an input image signal, if the entire image is continuously moved in a desired region.

### CROSS-REFERENCE TO RELATED APPLICATIONS

This application claims the benefit of Korean Patent Application No. 2002-79292 filed Dec. 12, 2002 in the Korean Intellectual Property Office, the disclosure of which is incorporated herein by reference.

### BACKGROUND OF THE INVENTION

1. Field of the Invention

The present invention relates to an apparatus, method, and medium including computer readable code for measuring noise of an image signal, and more particularly, to an apparatus, method, and medium including computer readable code for measuring noise of an image signal and precisely measuring noise in the input image signal regardless of a spatial frequency component of the input image signal, thereby increasing a noise removing efficiency.

2. Description of the Related Art

Generally, noise is generated in an image signal as the signal is applied to an image signal processing apparatus such as a TV or a video cassette recorder. The added noise in the image signal causes the degeneration of image quality. Therefore, in order to remove the added noise, various kinds of apparatuses have been developed for noise removal. However, noise removal efficiency is heavily dependent on an accuracy of the measurement of noise in the image signal.

FIG. 1 illustrates an example of a conventional apparatus for measuring noise. Referring to FIG. 1, the apparatus includes an SAD (Sum of Absolute Difference) operator 11, an SAD comparator 13, a first counter 15, a comparator 17, a second counter 19, and a multiplier 21. Here, the SAD operator 11, the SAD comparator 13 and the first counter 15 can be reset by a sampling frequency signal Fs.

The SAD operator 11 divides an input image signal into a plurality of blocks of pixel groups, about 175,000 blocks for example, and then calculates an SAD for each divided block.

The SAD calculated by the SAD operator 11 is transferred to the SAD comparator 13. The SAD comparator 13 determines whether the SAD received from the SAD operator 11 is between boundary values A and B. If it is determined that the received SAD is in between boundary values A and B, then SAD comparator 13 transfers a signal, such as an OK signal, to the first counter 15, indicating that the received SAD is in between the boundary values A and B. Accordingly, based on the signal from the SAD comparator 13, a counting value of the first counter 15 is also increased.

The first counter 15 is reset once in every picture period by a picture frequency signal Fp. Alternatively, the first counter 15 may be reset more or less than once in every picture period. For example, the first counter 15 may be reset once in every field period or in a plurality of field periods. In any case, a proper reset signal has to be applied to the first counter 15.

The SAD operator 11, the SAD comparator 13 and the first counter 15 are clocked based on the sampling frequency signal Fs. Furthermore, a value counted by the first counter 15 is compared with a desired value NE by the comparator 17. Here, the value NE is a predetermined integral value that is experimentally obtained. Preferably, the value NE is 496, corresponding to 0.28% of the entire number of blocks. A result compared by the comparator 17 is transferred to a second counter 19.

The second counter 19 increases or decreases a counting value according to the compared result. That is, if the value counted by the first counter 15 is greater than the value NE, the counting value of the second counter 19 is decreased. On the other hand, if the value counted by the first counter 15 is smaller than the value NE, the counting value of the second counter 19 is increased. Here, the second counter 19 is clocked by the signal by which the first counter 15 is reset, i.e., by the picture frequency signal Fp. Further, the counting value of the second counter 19 constitutes the noise measurement result, and also a low boundary value A and a high boundary value B of the SAD comparator 13. The high boundary value B is obtained by multiplying the low boundary value A by a value of “f” in the multiplier 21. Here, it is preferred that the value of “f” is set to 1.5. Alternatively, the high boundary value B of the SAD comparator 13 may depend on the counting value of the second counter 19, and the low boundary value A may have a fixed value, such as 0 or any positive integral number.

FIG. 2 illustrates an example of the SAD operator of FIG. 1. Referring to FIG. 2, the SAD operator 11 includes at least first through fourth delays 201, 205, 207 and 209, an absolute difference calculator 203, and first through third adders 211, 213 and 215.

The input image signal is delayed for one period of pixels by the first delay 201. At this time, the SAD is regarded as a value that is calculated by a difference between horizontally adjacent pixels. If the SAD is calculated on the basis of a difference between vertically adjacent pixels, the first delay 201 has to be a line delayer.

The absolute difference calculator 203 calculates an absolute difference between an input and an output of the first delay 201. The absolute difference calculated by the absolute difference calculator 203 is transferred to the second, third and fourth delays 205, 207 and 209 which are connected in turn.

The first adder 211 adds together the absolute difference calculated by the absolute difference calculator 201 and the absolute difference firstly delayed by the second delay 205. In addition, the second adder 213 adds the absolute difference secondly delayed by both the second and third delays 205 and 207 and the absolute difference thirdly delayed by all of the second, third and fourth delays 205, 207 and 209. The third adder 215 adds together a value added by the first adder 211 and a valued added by the second adder 213, with the value added by the third adder 215 being the SAD input to the SAD comparator 13.

However, in the above-mentioned conventional apparatus for measuring noise, since the noise is measured according to an SAD distribution of the image signal, there is a problem that a measured noise value may not accurately represent the actual amount of noise, according to a property of the image signal. For example, although an amount of noise may be the same in both an image that is complicated, or has a plurality of fine portions, and in an image that is simple and plane, or has a plurality of simple portions, the noise measurement may be different.

### SUMMARY OF THE INVENTION

Therefore, it is an aspect of the present invention to provide an apparatus, method, and medium including computer readable code for measuring noise of an image signal, which can measure the noise using a difference between pictures of the image and thus precisely measure the noise even between image signals of different properties.

Additional aspects and/or advantages of the invention will be set forth in part in the description which follows and, in part, will be obvious from the description, or may be learned by practice of the invention.

To achieve the above and/or other aspects and advantages of the present invention, there is provided an apparatus including a block average calculator dividing individual pictures of an input image signal into blocks and calculating average luminance values for a plurality of the divided blocks, a delay separately delaying the pictures of the input image signal by one period, an SAD calculator calculating an absolute difference between an average luminance value of a present picture and an average luminance value of a picture of the image signal delayed by the delay, and a picture noise selector selecting a desired number-th arranged absolute difference, of a plurality of calculations from the SAD calculator for the input image signal, as a picture noise when absolute differences calculated by the SAD calculator are arranged, in turn, from a smallest value toward a largest value.

The apparatus may further include a comparator comparing whether the average luminance value calculated by the block average calculator is within a desired range, wherein the SAD calculator calculates the absolute difference when it is determined by the comparator that the average luminance value is within the desired range. In addition, the apparatus may also include a regional noise selector selecting a desired arranged number-th picture noise as a regional noise when picture noises selected from pictures of the image signal in a desired region are arranged, in turn, from a smallest one toward a largest one.

To achieve the above and/or other aspects and advantages of the present invention, there is also provided a method of measuring noise, including dividing a picture of an input image signal into a desired number of blocks, calculating an average luminance value for each divided block, delaying the picture of the image signal by one period, calculating an absolute difference between the average luminance value of the picture and an average luminance value of a previous delayed picture of the image signal; and selecting a desired arranged number-th absolute difference as a picture noise when calculated absolute differences are arranged, in turn, from a smallest value toward a largest value.

The method may also include the operation of determining whether the calculated average luminance value is within a desired range, and calculating a corresponding absolute difference when it is determined that the average luminance value is within the desired range. Further, the method may include selecting an arranged desired number-th picture noise as a regional noise when selected picture noises in a desired region are arranged, in turn, from a smallest one toward a largest one.

To achieve the above and/or other aspects and advantages of the present invention, there is provided another method a method of measuring noise, including calculating an absolute difference between an average luminance value of a block of pixels of a first picture of an image signal and an average luminance value of a block of pixels of a second picture of the image signal, and selecting a calculated absolute difference of a plurality of calculated absolute differences as a picture noise.

The second picture is a picture may be sequentially next to the first picture in the image signal, and the selecting of the calculated absolute difference may include selecting a desired arranged number-th absolute difference as a picture noise from an arrangement of the plurality of calculated absolute differences.

To achieve the above and/or other aspects and advantages of the present invention, there is also provided an apparatus for measuring noise, including an SAD calculator calculating an absolute difference between an average luminance value of a block of pixels of a first picture of an image signal and an average luminance value of a block of pixels of a second picture of the image signal, and a picture noise selector selecting a calculated absolute difference of a plurality of calculated absolute differences as a picture noise.

Lastly, to achieve the above and/or other aspects and advantages of the present invention, there are also provided media including computer readable code to control a computer to determine noise of an input image signal according to any of the above discussed methods.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates an example of a conventional apparatus for measuring noise in an image signal;

FIG. 2 illustrates an example of an SAD operator of FIG. 1;

FIG. 3 illustrates an apparatus for measuring noise of an image signal, according to an embodiment of the present invention;

FIGS. 4A and 4B illustrate an interlaced scanning method and a progressive scanning method for explaining the apparatus of FIG. 3;

FIG. 5 illustrates a picture noise measurement operation, using the apparatus of FIG. 3, according to an embodiment of the present invention;

FIG. 6 illustrates a regional noise measurement operation using the apparatus of FIG. 3, according to an embodiment of the present invention; and

FIG. 7 is a flow chart of a noise measuring method using the apparatus of FIG. 3, according to an embodiment of the present invention.

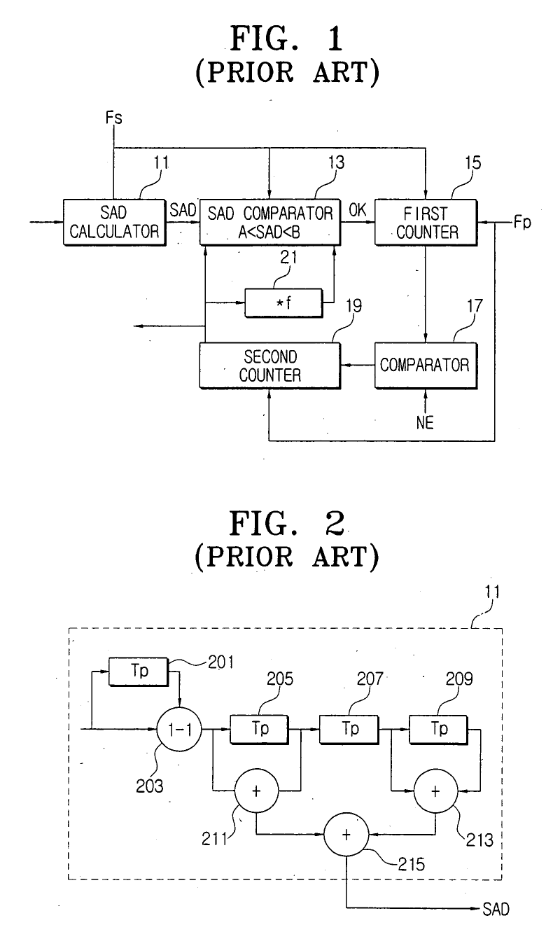

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

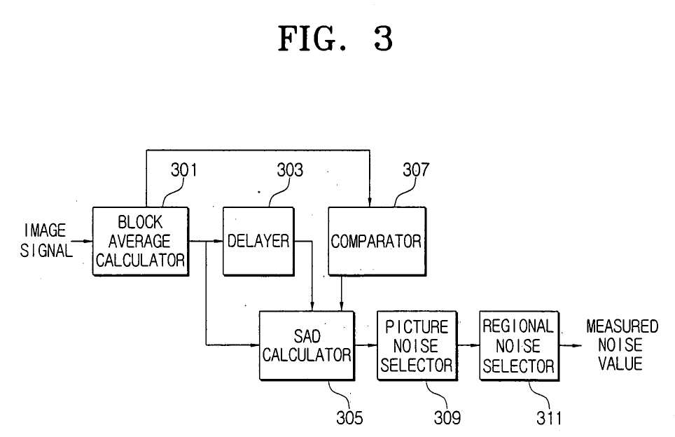

FIG. 3 illustrates an apparatus for measuring noise of an image signal, according to an embodiment of the present invention. Referring to FIG. 3, the apparatus for measuring noise includes a block average calculator 301, a delay 303, an SAD calculator 305, a comparator 307, a picture noise selector 309, and a regional noise selector 311.

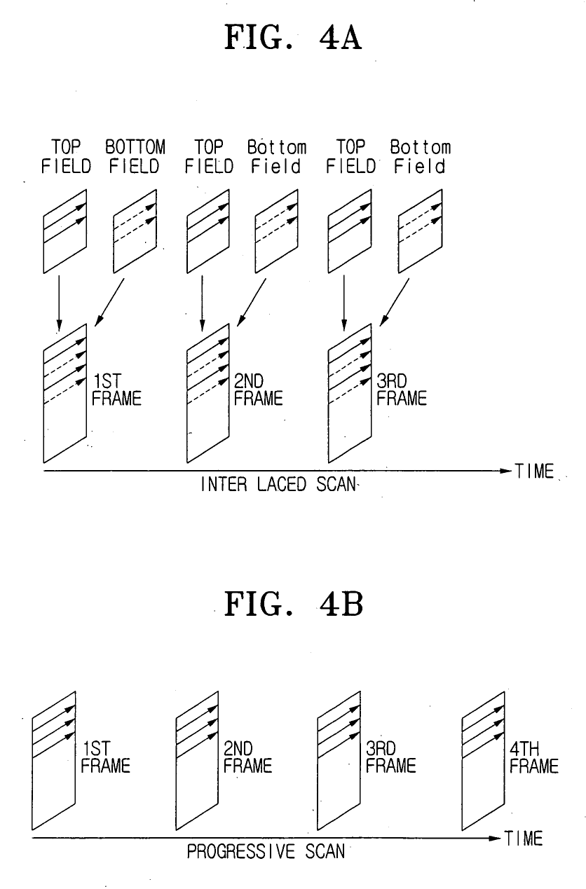

Methods of embodying a digital image may be distinguished as either an interlaced scanning method or a progressive scanning method. As illustrated in FIG. 4A, in the interlaced scanning method, two fields are scanned in turn by line, and in combination, complete one frame. In other words, only odd lines (solid lines in FIG. 4A) are scanned in a top field, and only even lines (dotted line in FIG. 4A) are scanned in a bottom field, then the two fields form one frame. On the other hand, as illustrated in FIG. 4B, the progressive scanning method is a high density and high image quality scanning method that has two times the scanning lines as the interlaced scanning method. As described above, according to these scanning methods, one field forms a “picture” of an image signal in the interlaced scanning method, and one frame forms the “picture” of the image signal in the progressive scanning method.

The block average calculator 301 divides a picture of an input image signal into a desired number of blocks and then calculates an average luminance value for each divided block. That is, the block average calculator 301 divides the field (interlaced) or frame (progressive) of the input image signal into the desired number of blocks. Here, one block has a pixel size of M×N. M represents the number of pixels in a horizontal direction, and N represents the number of pixels in a vertical direction. Furthermore, the block average calculator 301 calculates the average luminance value for each divided block. In other words, the block average calculator 301 sums up the luminance values of the pixels in each block, and then divides the summed value by the entire number of pixels, i.e., M×N, thereby calculating the average luminance value for each divided block.

The delay 303 delays the picture of the input image signal by one period. Here, the period means a time interval between a present input picture and the next input picture. For example, assuming that 60 frames of image signal are input in one second, in the progressive scanning method, a time delayed by the delay 303 will be 1/60 seconds.

The SAD calculator 305 calculates an absolute difference of the average luminance value of the present input picture and the delayed picture in a unit of block size. That is, the SAD calculator 305 calculates the absolute difference of the average luminance value between the present input picture and the previous picture, i.e., the SAD. Here, the SAD is calculated by evaluating a difference between the average luminance value of a block for the picture of the delayed image signal and the average luminance value of the corresponding block for the picture of the present image signal and then obtaining the absolute value of the difference. In this case, the SAD is calculated by comparing each block of the delayed picture and each block of the present image signal in a unit of block size. It is preferable that the compared blocks are in corresponding positions in each picture, although blocks from different corresponding positions could be compared. The SAD may also be calculated by comparing each block of the present picture with a block out of the blocks of the delayed picture, which has the average luminance value.

The apparatus for measuring the noise of the image signal may further include at least a comparator 307 determining whether the average luminance value calculated by the block average calculator 301 is within a desired range. In this case, a minimum threshold and a maximum threshold, both obtained through experimentation, are set in the comparator 307. Therefore, the comparator 307 compares whether the average luminance value calculated by the block average calculator 301 is between the minimum threshold and the maximum threshold. If the average luminance value calculated by the block average calculator 301 is smaller than the minimum threshold or larger than the maximum threshold, the comparator 307 informs the SAD calculator 305 that it is not necessary to calculate the absolute difference of the average luminance values of the blocks corresponding to the pictures of the present image signal and the delayed image signal. This is to exclude the blocks of extremely large or small average luminance values from the noise measuring operation, since the SAD of a block of extremely large or small average luminance values is smaller than the SAD of other blocks. Therefore, the SAD calculator 305 calculates the absolute difference only when the average luminance value of each block is larger than the minimum threshold and smaller than the maximum threshold, thereby preventing needless waste of resources when measuring the noise.

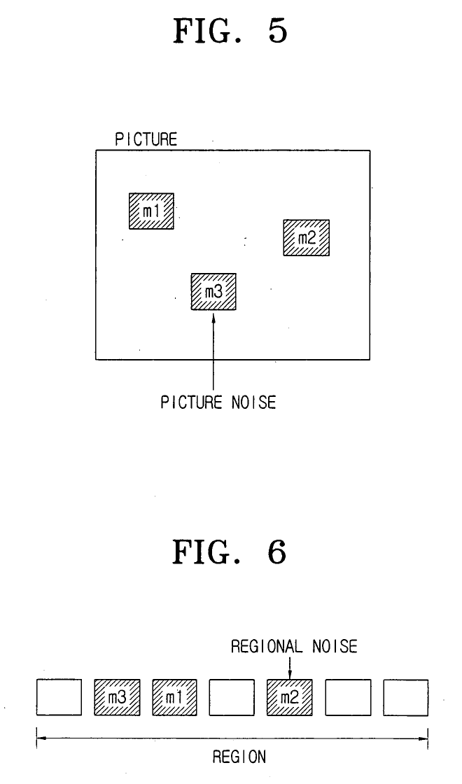

With the absolute differences calculated by the SAD calculator 305 being arranged in turn from the smallest toward the largest value, the picture noise selector 309 selects a particular number-th absolute difference as a picture noise. Here, the absolute difference that is the second smallest value, out of the absolute differences compared between the picture of the present image signal and the picture of the delayed image signal, is selected as the picture noise. That is, as shown in FIG. 5, assuming that the absolute differences calculated by the SAD calculator are arranged, in turn, from the smallest toward the largest value, e.g., m1, m2, m3, . . . , the picture noise selector 309 will select the second smallest absolute difference m2 as the picture noise. Generally, the SAD of the block including the motion is larger than the SAD of the motionless block. This SAD, as a factor of generating a block artifact, is processed through another image signal processing operation, and then excluded from the noise measuring operation.

The regional noise selector 311 selects a desired number-th picture noise as a regional noise, when the picture noises, for a plurality of pictures in a desired region, are arranged from the smallest toward the largest. Here, the regional noise selector 311 is set so as to select a second picture noise as the regional noise, as in the picture noise selector 309, as shown in FIG. 6. For example, assuming that 60 frames are input, in a second, in the progressive scanning method, the regional noise selector 311 will select the second smallest picture noise m2 out of the picture noises, which are selected by the picture noise selector 309 in the 60-frame region, as the picture noise. In case the entire image is moved, since the SADs of the all blocks of each picture are getting bigger, a value which is larger than an actual amount of the noise will be prevented from being measured as the picture noise. That is, if the entire image is continuously moved within a desired region, a variability of the measured noise value between the present region and the previous region lowers, thereby enabling the making of a stable measurement of the noise.

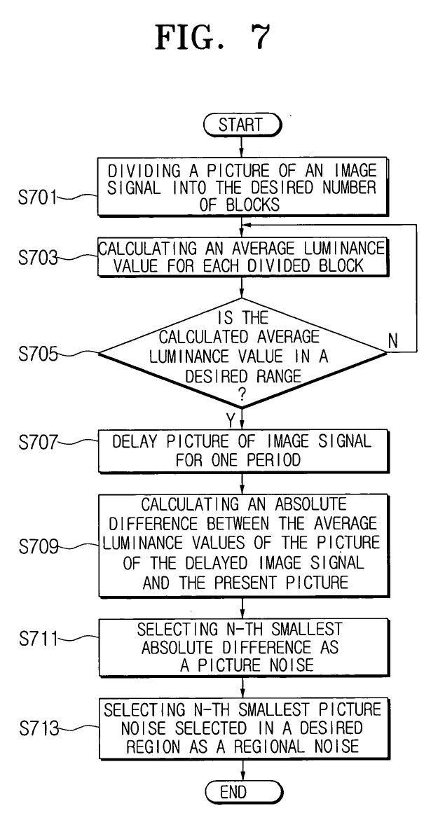

FIG. 7 is a flow chart of the method of measuring the noise using the apparatus of FIG. 3, according to an embodiment of the present invention.

As illustrated in FIG. 7, the block average calculator 301 divides the picture of the input image signal into the desired number of blocks (S701), and then calculates the average luminance value for each divided block (S703). In other words, the block average calculator 405 divides a frame or field of an input image signal into the desired number of blocks, each of which has a certain size.

The comparator 307 compares whether the average luminance value calculated by the block average calculator 301 is between a minimum threshold and the maximum threshold (S705). If the average luminance value calculated by the block average calculator 301 is smaller than the minimum threshold or larger than the maximum threshold, the comparator 307 informs the SAD calculator 305 that it is not necessary to calculate the absolute difference of the average luminance values of the blocks corresponding to the pictures of the present image signal and the delayed image signal.

In this operation, the delay 303 delays the picture of the input image signal by one period (S707). Here, the period means a time interval between a present input picture and a next input picture. For example, assuming that 60 frames of image signal are input in one second, in the progressive scanning method, a time delayed by the delay 303 will be 1/60 seconds.

The SAD calculator 305 calculates an absolute difference of the average luminance value of the present input picture and the delayed picture in a unit of block size (S709). That is, the SAD calculator 305 calculates the absolute difference of the average luminance value between the present input picture and the previous picture. Here, the SAD is calculated by evaluating a difference between the average luminance value of the corresponding block for the picture of the delayed image signal, and the average luminance value of the block for the picture of the present image signal and then obtaining the absolute value of the difference. In this case, the SAD is calculated by comparing corresponding blocks of the delayed picture and the present image signal. It is preferable that the compared blocks are in corresponding positions in each picture, although blocks from differing corresponding blocks could be compared. The SAD may also be calculated by comparing each block of the present picture with a block out of the blocks of the delayed picture which has the average luminance value.

When the absolute differences calculated by the SAD calculator 305 are arranged, in turn, from the smallest toward the largest value, the picture noise selector 309 selects a particular number-th absolute difference as a picture noise (S711). Here, the absolute difference that is the second smallest value, out of the absolute differences compared between the picture of the present image signal and the picture of the delayed image signal is selected as the picture noise.

The regional noise selector 311 selects a desired number-th picture noise as a regional noise (S713), when the picture noises selected from a plurality of pictures in a desired region are arranged, in turn, from the smallest toward the largest. Here, the regional noise selector 311 is set so as to select a second picture noise as the regional noise, as in the picture noise selector 309.

With the apparatus and method for measuring noise of an image signal, according to the present invention, needless waste of resources, e.g., time, for the measurement of noise can be prevented. In addition, if the entire picture continuously moves in certain regions, variation between the neighboring regions, i.e., between the previous and current regions can be reduced. As a result, noise measurement can be performed stably. Further, embodiments of the present invention further include a medium include computer readable code controlling a computer to perform the above methods and implement the control and/or operation of the above discussed apparatuses.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is

1. An apparatus for measuring noise, comprising:
a block average calculator dividing individual pictures of an input image signal into blocks and calculating average luminance values for a plurality of the divided blocks;
a delay separately delaying the pictures of the input image signal by one period;
an SAD calculator calculating an absolute difference between an average luminance value of a present picture and an average luminance value of a picture of the image signal delayed by the delay; and
a picture noise selector selecting a desired number-th arranged absolute difference, of a plurality of calculations from the SAD calculator for the input image signal, as a picture noise when absolute differences calculated by the SAD calculator are arranged, in turn, from a smallest value toward a largest value.

2. The apparatus of claim 1, further comprising a comparator comparing whether the average luminance value calculated by the block average calculator is within a desired range, wherein the SAD calculator calculates the absolute difference upon the comparator determining that the average luminance value is within the desired range.

3. The apparatus of claim 2, further comprising a regional noise selector selecting a desired arranged number-th picture noise as a regional noise when picture noises selected from pictures of the image signal in a desired region are arranged, in turn, from a smallest one toward a largest one.

4. The apparatus of claim 2, wherein the picture noise selector selects a second absolute difference as the picture noise.

5. The apparatus of claim 3, wherein the regional noise selector selects a second picture noise as the regional noise.

6. A method of measuring noise, comprising:
dividing a picture of an input image signal into a desired number of blocks;
calculating an average luminance value for each divided block;
delaying the picture of the image signal by one period;
calculating an absolute difference between the average luminance value of the picture and an average luminance value of a previous delayed picture of the image signal; and
selecting a desired arranged number-th absolute difference as a picture noise when calculated absolute differences are arranged, in turn, from a smallest value toward a largest value.

7. The method of claim 6, further comprising comparing whether the calculated average luminance value is within a desired range, and further comprising calculating a corresponding absolute difference upon determining that the average luminance value is within the desired range.

8. The method of claim 7, further comprising selecting an arranged desired number-th picture noise as a regional noise when selected picture noises in a desired region are arranged, in turn, from a smallest one toward a largest one.

9. The method of claim 7, wherein the selecting of the picture noise comprises selecting a second absolute difference as the picture noise.

10. The method of claim 8, wherein the selecting of the regional noise comprises selecting a second picture noise as the regional noise.

11. A method of measuring noise, comprising:
calculating an absolute difference between an average luminance value of a block of pixels of a first picture of an image signal and an average luminance value of a block of pixels of a second picture of the image signal; and
selecting a calculated absolute difference of a plurality of calculated absolute differences as a picture noise.

12. The method of claim 11, wherein the second picture is a picture sequentially next to the first picture in the image signal.

13. The method of claim 11, wherein the selecting of the calculated absolute difference includes selecting a desired arranged number-th absolute difference as a picture noise from an arrangement of the plurality of calculated absolute differences.

14. The method of claim 13, wherein the plurality of calculated absolute differences are arranged, in turn, from a smallest value toward a largest value

15. The method of claim 14, wherein the calculated absolute difference is selected to be the secondly arranged calculated absolute difference.

16. The method of claim 11, wherein the calculating of the absolute difference is only performed upon determining that an average luminance value is within a desired range.

17. The method of claim 11, wherein the selecting of the calculated absolute difference includes selecting a desired arranged number-th absolute difference as a regional noise from an arrangement of the plurality of calculated absolute differences.

18. An apparatus for measuring noise, comprising:
an SAD calculator calculating an absolute difference between an average luminance value of a block of pixels of a first picture of an image signal and an average luminance value of a block of pixels of a second picture of the image signal; and
a picture noise selector selecting a calculated absolute difference of a plurality of calculated absolute differences as a picture noise.

19. The method of claim 18, wherein the selecting of the calculated absolute difference includes selecting a desired arranged number-th absolute difference as the picture noise from an arrangement of the plurality of calculated absolute differences.

20. The method of claim 19, wherein the plurality of calculated absolute differences are arranged, in turn, from a smallest value toward a largest value

21. The method of claim 20, wherein the calculated absolute difference is selected to be the secondly arranged calculated absolute difference.
